(19) United States
(12) Patent Application Publication
(10) Pub. No.: US 2021/0062886 A1
(43) Pub. Date: Mar. 4, 2021

(54) ROLLING LOBE SEAL FOR AN AIR SPRING ASSEMBLY

(71) Applicant: GM GLOBAL TECHNOLOGY OPERATIONS LLC, Detroit, MI (US)

(72) Inventor: Jacek Marchel, Rochester Hills, MI (US)

(21) Appl. No.: 16/555,065

(22) Filed: Aug. 29, 2019

(51) Int. Cl. F16F 9/05; B60G 17/052; B60G 11/27

(52) U.S. Cl. CPC F16F 9/057; B60G 17/052; B60G 2206/424; B60G 2202/152; B60G 2204/126; B60G 11/27

(57) ABSTRACT

An air spring assembly includes a piston configured to couple to a suspension component, a top cap configured to couple to a vehicle frame, and a hollow guide tube having a first end coupled to the top cap and a second end provided with an aperture to the hollow. The piston passes through the aperture and is disposed at least partially within the guide tube. The assembly also includes a diaphragm disposed at least partially within the guide tube, disposed between and attached to the piston and the top cap. The assembly further includes a seal member having an outboard portion coupled to the guide tube proximate the second end, an inboard portion coupled to the outer periphery of the piston, and a membrane extending between the outboard portion and the inboard portion. The membrane defines a rolling lobe disposed between the guide tube and the piston.

### INTRODUCTION

The present invention relates generally to vehicle suspension systems, and more particularly to vehicle suspension systems employing air springs.

Some automobile and truck suspension systems include air springs mounted between an axle assembly or suspension system component and a vehicle frame or body. Air springs typically include a base mounted to the axle assembly, a top cap mounted to the frame, and a diaphragm disposed between and attached to the base and the cap. The diaphragm defines an inflatable compressed air cavity. The air cavity is compressible during operation of the vehicle to smooth the vehicle's ride.

### SUMMARY

An air spring assembly according to the present disclosure includes a piston configured to couple to a suspension component. The piston has an outer periphery. The assembly additionally includes a top cap configured to couple to a vehicle frame. The assembly also includes a hollow guide tube having a first end and a second end. The first end is coupled to the top cap. The second end is provided with an aperture to the hollow. The piston passes through the aperture and is disposed at least partially within the guide tube. The assembly further includes a diaphragm disposed at least partially within the guide tube. The diaphragm is disposed between and attached to the piston and the top cap. The diaphragm includes an inner surface defining a compressed air cavity. The assembly still further includes a seal member having an outboard portion, an inboard portion, and a membrane extending between the outboard portion and the inboard portion. The outboard portion is coupled to the guide tube proximate the second end. The inboard portion is coupled to the outer periphery of the piston. The membrane defines a first rolling lobe disposed between the guide tube and the piston.

In an exemplary embodiment, the diaphragm includes a second rolling lobe disposed between the guide tube and the piston. The second rolling lobe extends in a direction opposite the first rolling lobe. An air gap is thereby maintained between the first rolling lobe and the second rolling lobe.

In an exemplary embodiment, the outboard portion is coupled to an outer periphery of the guide tube. Such embodiments may also include a first clamp member disposed about the outer periphery of the guide tube. The first clamp member secures the outboard portion to the guide tube. Such embodiments may also include a second clamp member disposed about the outer periphery of the piston. The second clamp member secures the inboard portion to the piston.

In an exemplary embodiment, the seal member comprises natural rubber or an elastomer.

In an exemplary embodiment, the piston comprises a shock absorber.

An automotive vehicle according to the present disclosure includes a suspension, a frame, and an air spring assembly. The air spring assembly has a top cap coupled to the frame, a piston coupled to the suspension, and a hollow guide tube having a first end coupled to the top cap and a second end with an aperture to the hollow. The piston passes through the aperture and is disposed at least partially within the guide tube. The air spring assembly also includes a diaphragm disposed at least partially within the guide tube. The diaphragm is disposed between and attached to the piston and the top cap. The diaphragm includes an inner surface defining a compressed air cavity. The air spring assembly further includes a seal member having an outboard portion coupled to the guide tube proximate the second end, an inboard portion coupled to the outer periphery of the piston, and a membrane extending between the outboard portion and the inboard portion. The membrane defines a rolling lobe disposed between the guide tube and the piston.

In an exemplary embodiment, the diaphragm includes a second rolling lobe disposed between the guide tube and the piston. The second rolling lobe extends in a direction opposite the first rolling lobe. An air gap is thereby maintained between the first rolling lobe and the second rolling lobe.

In an exemplary embodiment, the outboard portion is coupled to an outer periphery of the guide tube. Such embodiments may also include a first clamp member disposed about the outer periphery of the guide tube. The first clamp member secures the outboard portion to the guide tube. Such embodiments may also include a second clamp member disposed about the outer periphery of the piston. The second clamp member secures the inboard portion to the piston.

In an exemplary embodiment, the seal member comprises natural rubber or an elastomer.

In an exemplary embodiment, the piston comprises a shock absorber.

As may be seen, the present disclosure provides a compact and robust assembly for sealing an air spring, which may increase reliability and, in turn, increase user satisfaction. The above and other additional advantages will be made clear in the description below and accompanying drawings.

### BRIEF DESCRIPTION OF THE DRAWINGS

FIG. 1 is a cross-section of a prior art air spring assembly;

FIG. 2 is a cross-section of an air spring assembly according to an embodiment of the present disclosure; and

FIG. 3 is a detail view of a rolling lobe seal assembly according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

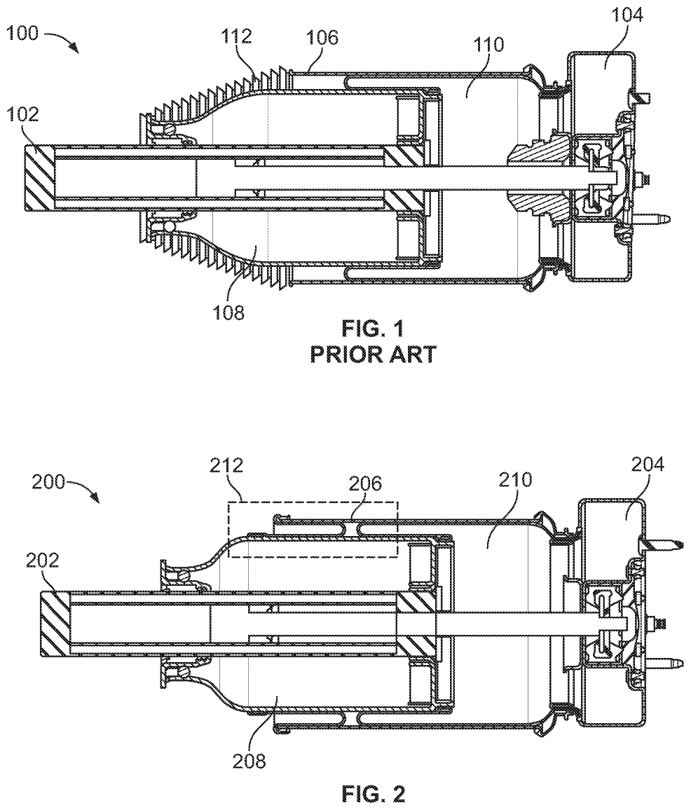

Referring now to FIG. 1, a prior art air spring assembly 100 is illustrated. The air spring assembly 100 includes an air spring base 102 that may be attached to a vehicle axle assembly. The assembly 100 also includes an air spring top cap 104 that may be attached to a vehicle frame. A guide tube 106 is fixedly coupled to the top cap 104. The guide tube 106 defines a generally hollow cylinder within which a piston 108 is disposed. The piston 108 may translate relative to the guide tube 106 along a central axis of the guide tube 106. The piston 108 is coupled to the base 102, such that relative motion between the axle assembly and frame causes relative movement between the piston 108 and the guide tube 106.

An air spring diaphragm 110 is disposed within the guide tube 106. The diaphragm 110 is attached to and seals between the piston 108 and the top cap 104. The diaphragm 110 includes an inner surface that defines a compressed air cavity between the base piston 108 and the top cap 104. The diaphragm 110 is formed of a resilient material and is attached to the top cap 104 at an upper edge thereof and to the piston 108 at a lower edge thereof. When the piston 108 and the cap 104 move towards each other, the air trapped in the compressed air cavity of the diaphragm 110 compresses, resulting in a greater resistance to continued relative movement between the axle assembly and the frame.

Because the diaphragm 110 is formed of a resilient material, debris infiltration into the guide tube 106 may adversely affect performance of the diaphragm 110, e.g. by rupturing the diaphragm 110 or inhibiting relative motion between the diaphragm 110 and guide tube 106. Known air spring assemblies 100 may therefore be provided with a protective accordion member 112, which may be referred to as a gaiter. The gaiter 112 forms a protective barrier at the end of the guide tube 106 proximate the base 102. Moreover, due to accordion features in the gaiter 112, the gaiter 112 may compress and expand in response to relative motion between the piston 108 and the cap 104, maintaining protective functionality during such motion.

However, such gaiters possess drawbacks in certain configurations. As an example, the accordion features impose packaging constraints, increasing the size of the assembly for a given length of travel. Moreover, such gaiters are typically provided with vent holes to relieve pressure change caused by a change in internal volume of the gaiter as the piston 108 moves relative to the cap 104, and such vent holes may permit debris to enter within the gaiter.

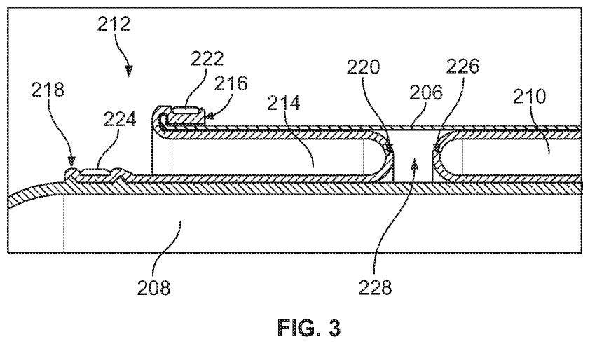

Referring now to FIGS. 2 and 3, an air spring assembly 200 according to the present disclosure is illustrated. The air spring assembly 200 includes an air spring base 202 that may be attached to a vehicle axle assembly (or other suspension component, such as a control arm). The base 202 may be formed of steel, aluminum, a composite material, or the like. In the illustrated embodiment the base 202 comprises a shock absorber; however in other embodiments the shock absorber may be omitted. The assembly 200 also includes an air spring top cap 204 that may be attached to a vehicle frame (or body, which will be considered equivalent to a frame in terms of describing and defining the invention herein). The cap 204 may also be formed of steel, aluminum, a composite material, or the like. The term vehicle frame as used herein includes the frame itself and any bracket affixed to the frame to mounting an air spring thereto. For a unibody vehicle, the air spring may be mounted to the body or a bracket affixed to the body.

A guide tube 206 is fixedly coupled to the top cap 204. The guide tube 206 defines a generally hollow cylinder extending from a first end, coupled to the top cap 204, to a second end, having an opening within which a piston 208 is disposed. The piston 208 may translate relative to the guide tube 206 along a central axis of the guide tube 206. The piston 208 is coupled to the base 202, such that relative motion between the axle assembly and frame causes relative movement between the piston 208 and the guide tube 206.

An air spring diaphragm 210 is disposed within the guide tube 206. The diaphragm 210 is attached to and seals between the piston 208 and the top cap 204. The diaphragm 210 includes an inner surface that defines a compressed air cavity between the base piston 208 and the top cap 204. The diaphragm 210 is formed of a resilient material, e.g. an elastomeric material such as rubber, and is attached to the top cap 204 at an upper edge thereof and to the piston 208 at a lower edge thereof. When the piston 208 and the cap 204 move towards each other, the air trapped in the compressed air cavity of the diaphragm 210 compresses, resulting in a greater resistance to continued relative movement between the axle assembly and the frame.

A rolling lobe seal assembly 212 is provided at an interface between the guide tube 206 and the piston 208. The rolling lobe seal assembly 212 includes a seal member 214 having an outboard portion 216, an inboard portion 218, and a rolling lobe 220 between the outboard portion 216 and the inboard portion 218. The seal member 214 comprises a flexible membrane formed out of a sealing material such as a natural rubber or elastomer.

The outboard portion 216 is secured to the second end of the guide tube 206, opposite the cap 204. In the illustrated embodiment, the second end of the guide tube 206 is provided with a lip about which the outboard portion 216 is disposed, and a first clamp member 222 extends about the outboard portion 216 to secure the outboard portion 216 in the desired location relative to the guide tube 206. The first clamp member 222 may be any suitable clamping device, e.g. a worm drive clamp. However, in other embodiments other securing methods may be used, e.g. by stretching the outboard portion 216 and snap-fitting the outboard portion 216 about the periphery of the second end of the guide tube 206. As another alternative, the outboard portion 216 may be secured to an inner periphery of the second end of the guide tube 206, e.g. via adhesive.

The inboard portion 218 is secured to the outer periphery of the piston 208. In the illustrated embodiment the outer periphery of the piston 208 is provided with a groove within which the inboard portion 218 is disposed, and a second clamp member 224 extends about the inboard portion 218 to secure the inboard portion 218 in the desired location relative to the piston 208. The second clamp member 224 may be any suitable clamping device, e.g. a worm drive clamp. However, in other embodiments other securing methods may be used, e.g. adhesive.

While the inboard portion 218 is depicted as being positioned further from the cap 204 than the outboard portion 216, the precise configuration may be selected as appropriate for any given implementation. Moreover, the relative positions of the inboard portion 218 and outboard portion 216 may vary during operation, as will be discussed in further detail below.

The rolling lobe 220 is formed at a central portion of the seal member 214 between the outboard portion 216 and the inboard portion 218. The rolling lobe 220 extends between the outer periphery of the piston 208 and the inner periphery of the guide tube 206, in a direction toward the cap 204. Whereas the inboard and outboard portions 218, 216 are coupled to the piston 208 and guide tube 206, respectively, the position of the rolling lobe 220 relative to the outer periphery of the piston 208 and the inner periphery of the guide tube 206 may change in response to relative motion between the piston 208 and guide tube 206.

A diaphragm rolling lobe 226 of the diaphragm 210 likewise extends between the piston 208 and guide tube 206, in a direction toward the second end of the guide tube 206. The diaphragm rolling lobe 226 may likewise move in response to relative motion between the piston 208 and guide tube 206. An air gap 228 is thereby maintained between the rolling lobe 220 and the diaphragm rolling lobe 226 as the piston 208 and guide tube 206 move among their various respective positions. Because the air gap 228 is generally constant among the range of relative motion between the piston 208 and guide tube 206, it is unnecessary to compensate for any changes in pressure as the piston 208 moves relative to the guide tube 206. The rolling lobe 220 may therefore be provided as an integral piece with no vent holes through which debris or liquid could infiltrate.

Advantageously, because the rolling lobe seal assembly 212 is disposed predominantly within the guide tube 206, an air spring assembly 200 according to the present disclosure is more compact than comparable prior art assemblies having external gaiters as illustrated in FIG. 1.

As may be seen, the present disclosure provides a compact and robust assembly for sealing an air spring, which may increase reliability and, in turn, increase user satisfaction.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An air spring assembly for use in a vehicle suspension system comprising:
a piston configured to couple to a suspension component, the piston having an outer periphery;
a top cap configured to couple to a vehicle frame;
a hollow guide tube having a first end and a second end, the first end being coupled to the top cap, the second end being provided with an aperture to the hollow, the piston passing through the aperture and being disposed at least partially within the guide tube;
a diaphragm disposed at least partially within the guide tube, the diaphragm being disposed between and attached to the piston and the top cap, the diaphragm including an inner surface defining a compressed air cavity; and
a seal member having an outboard portion coupled to the guide tube proximate the second end, an inboard portion coupled to the outer periphery of the piston, and a membrane extending between the outboard portion and the inboard portion, the membrane defining a rolling lobe disposed between the guide tube and the piston.

2. The air spring assembly of claim 1, wherein the diaphragm includes a second rolling lobe disposed between the guide tube and the piston, the second rolling lobe extending in a direction opposite the rolling lobe, a gap being maintained between the rolling lobe and the second rolling lobe.

3. The air spring assembly of claim 1, wherein the outboard portion is coupled to an outer periphery of the guide tube.

4. The air spring assembly of claim 3, further comprising a first clamp member disposed about the outer periphery of the guide tube, the first clamp member securing the outboard portion to the guide tube.

5. The air spring assembly of claim 4, further comprising a second clamp member disposed about the outer periphery of the piston, the second clamp member securing the inboard portion to the piston.

6. The air spring assembly of claim 1, wherein the seal member comprises natural rubber or an elastomer.

7. The air spring assembly of claim 1, wherein the piston comprises a shock absorber.

8. An automotive vehicle comprising:
a suspension;
a frame; and
an air spring assembly having a top cap coupled to the frame, a piston coupled to the suspension, a hollow guide tube having a first end and a second end, the first end being coupled to the top cap, the second end being provided with an aperture to the hollow, the piston passing through the aperture and being disposed at least partially within the guide tube, a diaphragm disposed at least partially within the guide tube, the diaphragm being disposed between and attached to the piston and the top cap, the diaphragm including an inner surface defining a compressed air cavity, and a seal member having an outboard portion coupled to the guide tube proximate the second end, an inboard portion coupled to the outer periphery of the piston, and a membrane extending between the outboard portion and the inboard portion, the membrane defining a rolling lobe disposed between the guide tube and the piston.

9. The automotive vehicle of claim 8, wherein the diaphragm includes a second rolling lobe disposed between the guide tube and the piston, the second rolling lobe extending in a direction opposite the rolling lobe, a gap being maintained between the rolling lobe and the second rolling lobe.

10. The automotive vehicle of claim 8, wherein the outboard portion is coupled to an outer periphery of the guide tube.

11. The automotive vehicle of claim 10, further comprising a first clamp member disposed about the outer periphery of the guide tube, the first clamp member securing the outboard portion to the guide tube.

12. The automotive vehicle of claim 11, further comprising a second clamp member disposed about the outer periphery of the piston, the second clamp member securing the inboard portion to the piston.

13. The automotive vehicle of claim 8, wherein the seal member comprises natural rubber or an elastomer.

14. The automotive vehicle of claim 8, wherein the piston comprises a shock absorber.
